(19) United States
(12) Patent Application Publication
(10) Pub. No.: US 2010/0309023 A1
(43) Pub. Date: Dec. 9, 2010

(54) Traffic Control System

(76) Inventor: Alexander Busch, Sunnyvale, CA (US)

Correspondence Address: BARLEY SNYDER, LLC, 1000 WESTLAKES DRIVE, SUITE 275, BERWYN, PA, 19312, US

(21) Appl. No.: 12/479,452

(22) Filed: Jun. 5, 2009

(51) Int. Cl. G08G 1/08

(52) U.S. Cl. 340/917

(57) ABSTRACT

A virtual road loop detector has a traffic control system that sends out a signal identifying location and intersection. The traffic control system, used for efficiently switching a traffic control switch, includes an intersection control module that communicates with a vehicle control module in order to determine if the traffic switch changes. The intersection control module is designed to send information regarding the intersection, which provides a virtual loop detector that assists in identify incoming vehicles and relevant switch requests from those vehicles. The virtual loop detector is a theoretical loop and defined by a pre-determined dimension from the intersection. The vehicle control module is provided to identify location and analyze information received from the intersection control system, such as proximity to or within the virtual loop detector. A light switch request may be sent by the incoming vehicle when the vehicle receives signals from the intersection and is traveling toward that same intersection. The intersection control module would then receive any information and light switch requests from the vehicle or any other incoming traffic. An analysis is performed by the intersection control module with regard to various incoming traffic information and requests in order to determine if the traffic light changes from a light schedule.

### FIELD OF THE INVENTION

The invention relates to a traffic control system that implements a virtual loop detector for roadway intersections and controls incoming vehicle right of way using a series of communications between an intersection hub and incoming traffic.

### BACKGROUND

Currently, some roads are equipped with inductive loop detectors to assist with traffic flow, using electromagnetic communication and a detection system, which relies on the fact that a moving magnet will induce a electrical current in a nearby conducting wire. Fundamentally, the inductive loop detector is capable of detecting the bottom of (metal) cars, which then registers with a processing unit in order to determine if a traffic light should change.

Many of these inductive loop detectors can detect passing and stopping cars, and generally, they have the capability to count passing vehicles. However, most loop detectors are set into a “pulse mode” that does not count cars, but rather only detects cars waiting on it (by sending a pulse into the loop frequently). Furthermore, inductive loop detectors cannot accurately determine incoming speed of vehicles. Most of the known inductive loop detectors are installed close to the stop line, which is the biggest disadvantage, because earlier detection of approaching cars would provide more efficient light changes.

Generally, these loop detectors require installation in the pavement, which makes the installation expensive. They have a high failure rate and break down after a couple of years, and since they are embedded in the pavement, maintenance is expensive, as well. Overall, conductive loop detectors, although proven to assist with traffic flow at an intersection, are expensive and cannot efficiently detect oncoming vehicles, which would prove worthy of more efficient light changes.

For instance, one practical problem encountered at most intersections: the traffic lights are all switched to green in one direction of a main road, and cars coming into the intersection from secondary road have to come to a full stop first, because their traffic lights are red then. The loop detector has to first conductively detect the car at a stop, and within one to several seconds the traffic light turns to green (assuming it is determined that there is no cross traffic coming from the main road). That means incoming vehicle have to come to a complete stop at the intersection of the main road and the secondary road, which costs times, increases the CO₂/NOx emissions, decreases gas mileage and creates noise on acceleration.

As discussed, the use of physical loop detectors in conventional traffic switching systems is primitive and conventionally used only to detect the existence of traffic in a specific direction. Current systems also cannot receive information from other sources to determine whether to change the light for a particular vehicle. Other systems have been developed to solve this problem by allowing the drivers of certain vehicles to send a signal to the traffic switch in order to change the traffic light. However, the problem with such a system is that it cannot prioritize different signals coming from separate vehicles. In addition, the drivers of such vehicles can switch traffic signals in their favor even if it is not essential.

U.S. Pat. No. 6,064,319 discloses a method and system for detecting a vehicle's presence at or approaching a traffic light and determining whether to change the traffic light in response to that vehicle. A virtual detection loop 22′ is established on road 14′ proximate to the intersection 18′, and the location of the virtual detection loop is stored in a vehicle tracking unit 20′, located on a vehicle 12′. The virtual detection loop 22′ is not a physical component, but rather a set of boundaries defined in a coordinate system. The boundaries of the virtual detection loop 22′ are defined in the coordinate system used by the vehicle tracking unit 20′, such as latitude and longitude coordinates. The size and position of the virtual detection loop 22′ is dependent upon a number of factors including, but not limited to, the accuracy of the vehicle tracking unit 20′, the anticipated speed of the vehicle 12′, and the unique characteristics of each intersection 18′. A vehicle 12′ traveling on the road 14′ toward the traffic intersection 18′ enables the vehicle tracking unit 20′ to continuously receive signals from global positioning satellites 24′, 26′, and 28′, and, in response, determines the location of the vehicle 12′ on road 14′. When the vehicle tracking unit 20′ determines that the vehicle 12′ has entered the virtual detection loop 22′, the vehicle tracking unit ascertains whether control of the traffic light 10′ should be preempted. The vehicle tracking unit 20′ sends an information signal 30′ to a control system 32′ if control of the traffic light 10′ is to be preempted. The control system 32′ determines whether the traffic light 10′ should be switched based on the content of the information signal 30′ and the current status of the traffic light 10′ (e.g., whether or not it is in favor of the vehicle). If the control system 32′ determines that the traffic light 10′ should be switched, then a control signal 34′ is sent from the control system 32′ to the traffic light 10′ to switch the traffic light 10′.

Such a system is dependent on the vehicle tracking unit 20′ that operates to store the locations of one or more virtual detection loops 22′, the location of one or more traffic signals 10′, and other information such as route scheduling. The location of the virtual detection loops 22′ and the traffic signals 10′ on the digitized map with coordinates are downloaded to the vehicle tracking unit computer 50′.

### SUMMARY

Accordingly, the present invention was devised in light of the problems described above, the invention relates to a traffic control system that sends out signals to incoming traffic, identifying location and intersection, while also preparing a virtual loop detector.

The traffic control system, used for efficiently switching a traffic control switch, includes an intersection control module that communicates with a vehicle control module in order to determine if the traffic switch changes. The intersection control module is designed to send information regarding the intersection, which provides a virtual loop detector that assists in identify incoming vehicles and relevant switch requests from those vehicles. The virtual loop detector is a theoretical loop and defined by a pre-determined dimension from the intersection. The vehicle control module is provided to identify location and analyze information received from the intersection control system, such as proximity to or within the virtual loop detector. A light switch request may be sent by the incoming vehicle when the vehicle receives signals from the intersection and is traveling toward that same intersection. The intersection control module would then receive any information and light switch requests from the vehicle or any other incoming traffic. An analysis is performed by the intersection with regard to various incoming traffic information and requests in order to determine if the traffic light changes from a light schedule.

### BRIEF DESCRIPTION OF THE DRAWINGS

The invention will be explained in greater detail with reference to embodiments, referring to the appended drawings, in which:

FIG. 1 is a graphical representation of a known method and system for detecting vehicle presence at or approaching an intersection;

FIG. 2 is a flow diagram detailing how the known system detects vehicle presence and determines when to switch the light;

FIG. 3 is another flow diagram detailing how the known system detects vehicle presence and determines when to switch the light;

FIG. 4 is a flow diagram of a traffic control system for signaling and changing a traffic switch according to the invention;

FIG. 5 is a top view of an intersection having a known conductive loop detectors;

FIG. 6 is a top view of an intersection having the traffic control system included with a virtual loop detector according to the invention;

FIG. 7 is a graphical representation of the traffic control system illustrating the virtual loop detector;

FIG. 8A is a top view of an alternate embodiment of the traffic control system having multiple control modules;

FIG. 8B is a top view of an alternate embodiment of the traffic control system having multiple transceivers;

FIG. 9 is a flow diagram detailing how the traffic control system may determines if a traffic light should change; and

FIG. 9 is a flow diagram detailing another process on how the traffic control system may determines if the traffic light should change.

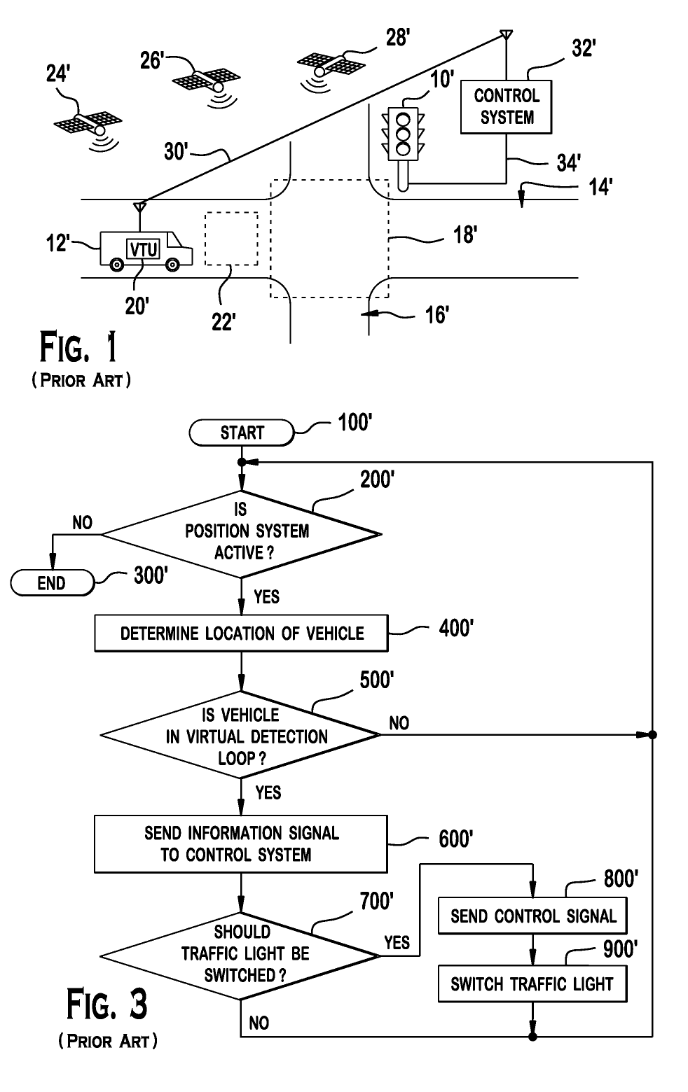

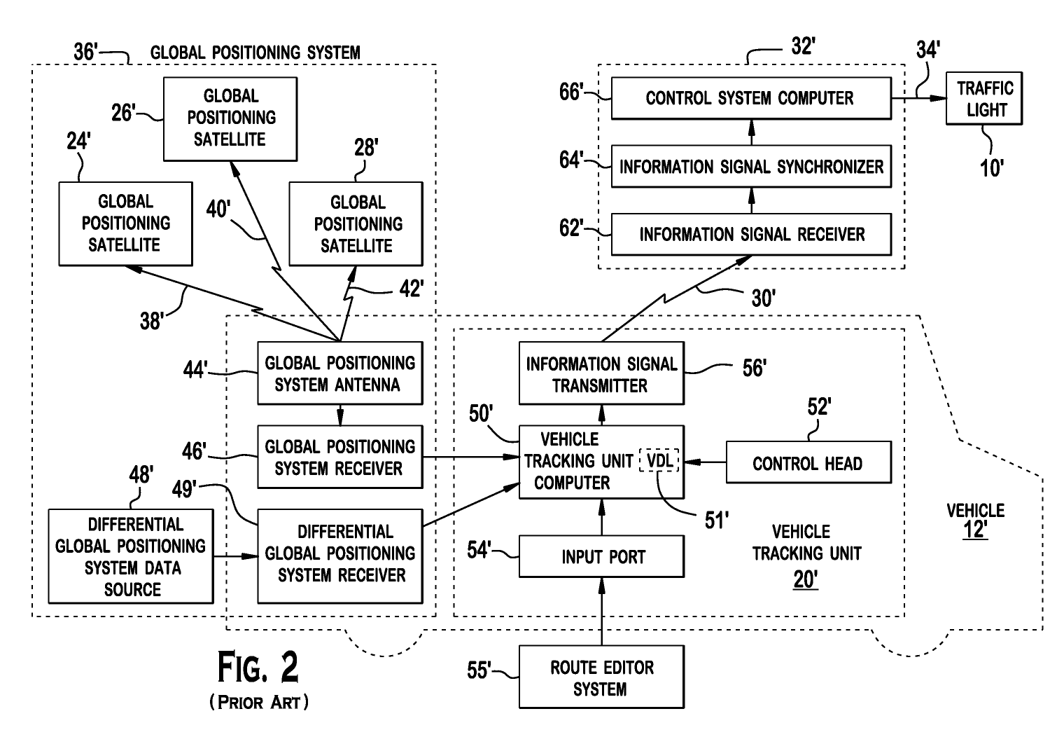

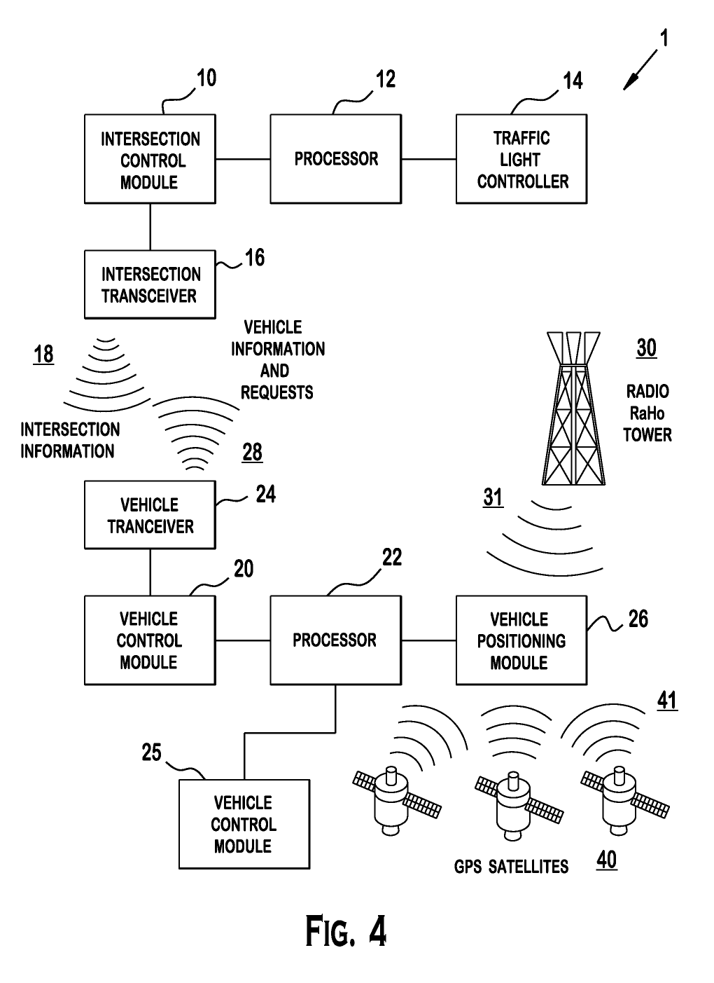

### DETAILED DESCRIPTION THE PREFERRED EMBODIMENT(S)

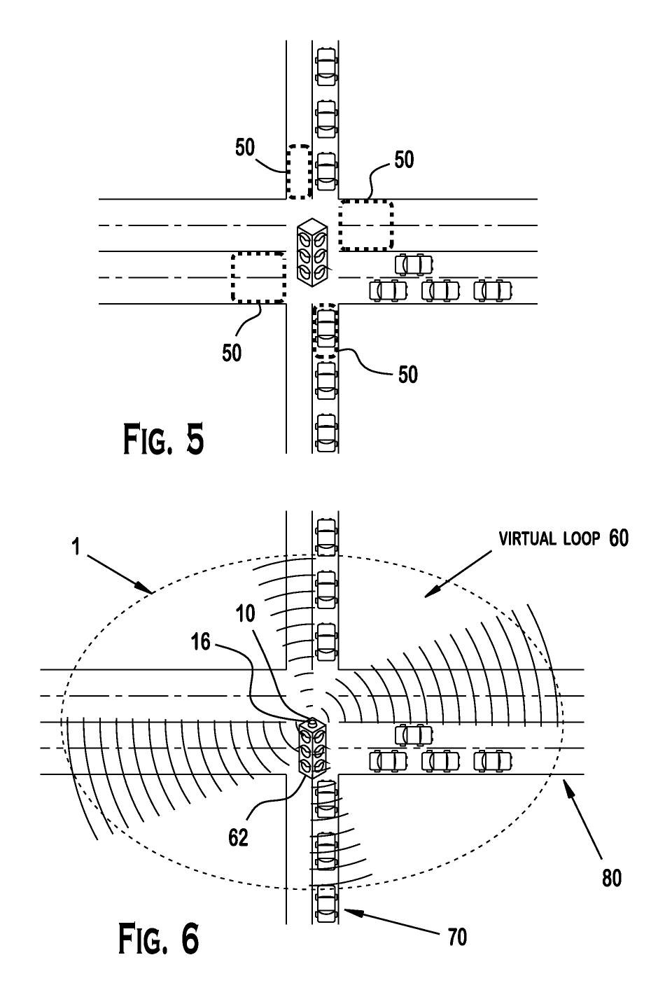

The invention will now be described in greater detail with reference to FIGS. 4-9.

The present invention relates to a traffic control system 1 that is used efficiently control traffic flow of incoming vehicles. This is performed by determining when to switch an intersection light efficiently and appropriately, and more specifically by analyzing information between an intersection control module 10 and incoming vehicles. Once determined, the intersection control module 10 sends a switch signal to the traffic light to switch direction of traffic flow (red light to green light).

The traffic control system 1, as shown in FIG. 4, incorporates communication between several modules including, but not limited to, the intersection control module 10, a traffic light controller module 14, a vehicle control module 20 from an incoming vehicle, and a vehicle-positioning module 26 in FIG. 4.

The intersection control module 10, in the embodiment shown, connects directly to a processor 12 and a traffic light controller module 14 using hard-wired communications. It is possible, however, to incorporate the processor 12 and/or the traffic light controller module 14 as an integral design of the intersection control module 10. As an alternative, the intersection control module 10 could also connect to any of the aforementioned modules indirectly, using wireless communications. In fact, communication is the heart of the traffic control system 1, and essential to establish switch requests between the intersection control module 10 and the vehicle control module 20 (which will be discussed below).

The intersection control module 10, having an intersection transceiver 16, disseminates signals 18 in all directions, with the signals 18 including information regarding the intersection such as dimensioning and location. The signals 18 travel away from the intersection and are cap bitable so that the signals 18 are detectable to all incoming traffic.

The vehicle control module 20 includes a vehicle transceiver 24 that is capable of receiving any signals 18 sent from the intersection control module 10. The signals 18 that are detected are also captured by the vehicle transceiver 24, and then further relayed to the vehicle control module 20 for processing of the sent information. As a result, a connection between the intersection control module 10 and the vehicle control module 20 is established, and a potential to communicate information is realized.

The vehicle transceiver 24 may be designed and prepared in a variety of ways, such as an external component connecting to the vehicle control module 20, or an integral component of the vehicle control module 20. In the embodiment shown, the vehicle transceiver 24 is designed as an external component to the vehicle control module 20. As such, then it is also is possible to have the vehicle transceiver 24 placed in strategic position around the vehicle to better receive and accept incoming signals 18. As a result, though, the vehicle transceiver 24 would have to indirectly or directly connect with the vehicle control module 20. This connection may be established in several ways; however, it would most notably require either a direct wire connection or wireless technology. In the embodiment shown, the vehicle control module 20 would also include a processor 22 to process information carried by the incoming signals 18, and a vehicle-positioning module 26. Either of which may be an integral component by design or a separate module all together.

The vehicle-positioning module 26 is utilized to determine the approximate position of the vehicle, which may be performed by connecting to one or more vehicle tracking systems. As a result, the vehicle-positioning module 26 can determine the approximate or precise location of the vehicle to which it is attached. That position is then recorded at regular intervals into the vehicle-positioning module 26 or into a memory 25, which is either connected to the processor 22 or the vehicle-positioning module 26. Knowledge as to the location of the incoming vehicle is critical to the traffic control system 1, because the intersection control module 10 will not switch the traffic light from its schedule unless the vehicle is in a virtual loop detector 60 (discussed below).

The vehicle tracking system, as described above, is any type of system that utilizes a communications component to identify the approximate or precise location of a vehicle. The vehicle-positioning module 26 would only require the use of vehicle tracking system that has at least sub-10 meter accuracy. In the embodiment shown, the vehicle tracking system would use a communications component, such as radio towers 30 or satellite 40 transmitters, with a mobile unit (vehicle-positioning module 26) to receives information from the communications component. The received information is then analyzed to determine the approximate or precise vehicle position. Once the location is established, it is also possible to communicate that position to other vehicle components. The position may additionally be displayed using an on-board component displaying an electronic map (not shown), as is commonly known.

For instance, a Global Position Systems (GPS) 41 could be one type of vehicle tracking system used, whereby the GPS 41 utilizes satellites 40 to transmit signals that are then sent to and received by the vehicle-positioning module 26 (a global positioning receiver). The vehicle-positioning module 26 would first locate four or more GPS satellites 40, and then calculate the distance to each satellite 40 by analyzing information sent in signals sent from the satellites 40. This analysis, which is relatively known in the art and performed by the vehicle-positioning module 26, determines the approximate, if not precise, vehicle position in real time.

An alternative cellular technology 31, that utilizes radio towers 30, may be used as well, although not as robust. In fact, mobile positioning, using a handheld device, like a mobile device, is also possible, wherein the approximate position of a mobile phone (not shown) is tracked. Since, the mobile phone would be in an approximate position to the vehicle, the vehicle position would also be determined. However, an additional connection between the mobile phone and vehicle-positioning module 26 would have to be established. Bluetooth technology is one type of technology that would establish a wireless protocol for exchanging data over short distances between the vehicle-positioning module 26 and the mobile device (not shown). Therefore, a personal area network (PAN) is created.

Regardless of the technology used, the traffic control system 1 may use a vehicle tracking system or positioning method, such as predictive positioning (described below), to determine an approximate or precise position of the vehicle. For the traffic control system 1 to function robustly, identifying the proximity of the incoming vehicle in regard to the virtual loop detector 60 may be necessary.

The traffic control system 1 relies on a two-way communication system to work efficiently as well. Therefore, communication must occur between both the intersection and vehicle components to function. Therefore, the vehicle-positioning module 26 should communicate back with the intersection control module 10. This communication is performed using the vehicle transceiver 24. Signals 28, carrying vehicle information and requests, are transmitted through the vehicle transceiver 24 and received by the intersection transceiver 16.

In the embodiment shown, the traffic control system 1 performs communications between the intersection control module 10 and the vehicle control module 20 using dedicated short-range communication (DSRC) technology. However, other communication technologies known to the art may be used.

Dedicated short-range communications (DSRC) are one-way or two-way short- to medium-range wireless communication channels, specifically designed for automotive use. Each transceiver 16, 24 would be able to receive and send DSRC signals. It is also possible to establish communication capabilities using wireless LAN (WLAN) technology, where a wireless local area network that links two or more devices using spread-spectrum or OFDM modulation technology. Much like DSRC technology, communication between devices is limited in area. In addition to DSRC and WLAN/WiFi and other known technologies, the traffic control system could work with 3G and 4G (cellular) technologies.

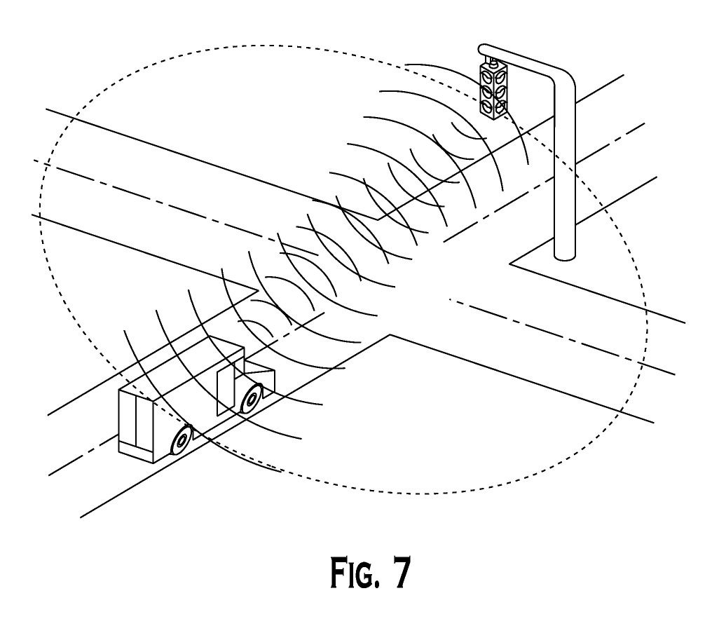

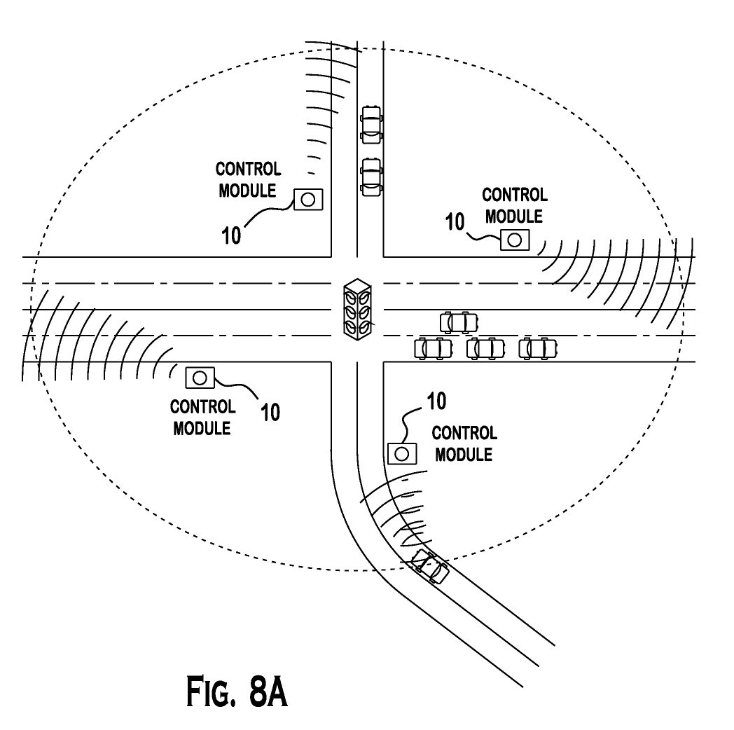

Now referring to FIGS. 5 and 6, a same intersection is shown in both illustrations. However, the intersection in FIG. 5 includes illustration of a traditional inductive loop system, while the traffic control system 1 replaces the traditional inductive loop system in FIG. 6.

Currently, most intersections are equipped with inductive loop detectors 50 having coiled wire embedded in the surface of the road and capable of detecting the metal undercarriage of stopped vehicles. Although inductive loop detectors 50 can detect slowly passing and stopping vehicles, inductive loop detectors 50 cannot count vehicles passing through the intersection, nor can they accurately determine the speed of passing vehicles. Furthermore, no communication is performed between the incoming vehicle and the intersection. Rather, the inductive loop detector 50 constantly tests the inductance of the loop, which is embedded in pavement. If the intersection determines that a car is stopped (change in inductance), then the inductive loop detector 50 concludes that the vehicle is waiting for a light change. Then the inductive loop detector 50 will send a signal to change the light without any information on other incoming cross-traffic or number of vehicles outside the inductive loop detector 50 range, which is essentially the dimension of coiled wire embedded in the concrete.

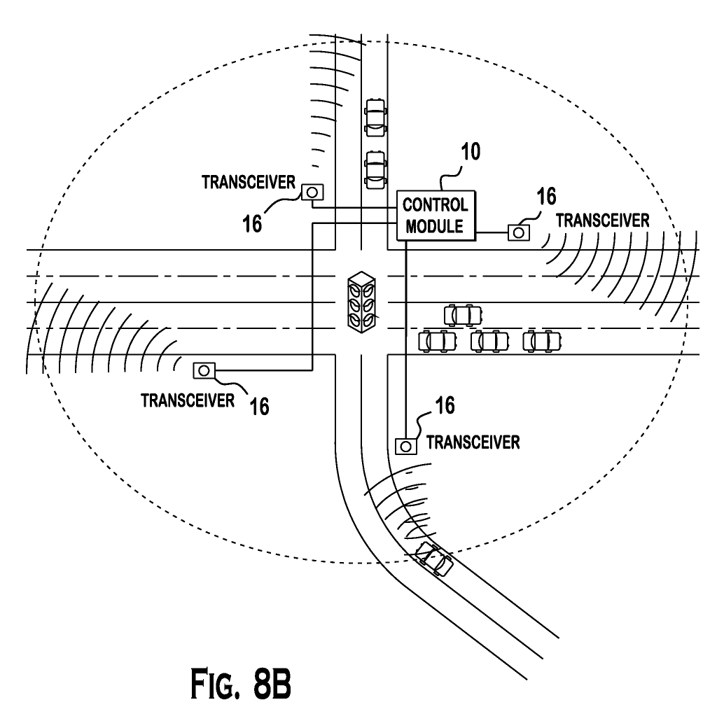

In FIGS. 6 and 7, the traditional inductive loop detector 50 is replaced with traffic control system 1, according to the invention. The intersection control module 10 is the hub of the traffic control system 1, sending information regarding the intersection to incoming traffic. The intersection control module 10, which is positioned near the intersection, provides the virtual loop detector 60. The virtual loop detector 60 is fundamentally a boundary or theoretical loop defined by set dimensions from the intersection, or a set distance in all directions from the traffic light 62. In the embodiment shown, this is possible, because the intersection transceiver 16, which sends the signals 18, is positioned at the top of the traffic light 62. Signals 18, carrying information about the intersection, are sent from the intersection transceiver 16 and carry as far as the communication technology permits. Although the dimension of the virtual loop detector 60 could be the distance traveled by the sent signals 18, the dimensions of the virtual loop detector 60, in the embodiment shown, is defined by a pre-determined distance from the intersection. Additionally, the dimension of the virtual loop detector 60 could be construed as a ratio the signal 18 distances, in various directions. For instance, the virtual loop detector 60 may be pre-programmed to be 25 yards from the intersection for side roadways 70, while the virtual loop detector 60 may be pre-programmed to be 50 yards from the intersection for main roadways 80. Faster incoming vehicles, coming from the main roadways 80, would be determined within in the virtual loop detector 60 as distance further from the intersection than vehicles traveling along side roadways 70. Along side roadways 70, it may not be necessary to detect vehicles as far out as the vehicles traveling along the main roadways 80. Therefore, the virtual loop detector 60 dimensions may be closer to the intersection, and as a result, the traffic control system 1 could adapt to any configuration of convening roadways.

Although the virtual loop detector 60 is illustrated as having an elliptical shape in the embodiment shown, the virtual loop detector 60 would not have a preferred shape. Rather, the virtual loop detector 60 shape would be defined by the minimum distance required between the intersection and the incoming vehicles to allow a request to change the intersection light, as well as the shape formed by convening roadway configurations. Since roadways can be configured differently configured (i.e. landscape geometry, number of lanes, direction of traffic flow, etc.), the traffic control system 1 can be modified to prepare a virtual loop detector 60 that conforms to those configurations in order to efficiently control traffic flow.

In FIG. 7, the intersection control module 10 includes the intersection transceiver 16, the processor 12, and the traffic light controller module 14, all of which are designed integral with the top of a traffic light 62. However, it is possible to have the same intersection control module 10 positioned any where near the intersection, and connecting the other modules as described above. However, having the intersection control module 10 positioned at the top of the traffic light provides a more robust communication between the intersection control module 10 and the incoming vehicles since there is less chance of signal interference. The signal can carry further from the top of the traffic light 62 than from a position closer to the roadway, as well. If the intersection control module 10 is positioned away from the top of the traffic light 62, then it would be advantageous to position the intersection transceiver 16 at the top of the traffic light, in order to robustly send signals toward the incoming traffic. However, such a configuration is not necessary for function of the traffic control system 1. In other embodiments, the intersection transceiver 16 could be positioned further down the road, in order to minimize interference and provide robust communication.

It is unlikely that roadways, leading into the intersection, will always be straight paths. Rather, many of the roadways will wind and bend into the intersection. Additionally, their paths will include obstacles that may interfere with the communication between the intersection control module 10 and the vehicle control module 20. Obstacles, such as a mountain or a tunnel, could cause interference in that communication, and could provide inefficient operation of the traffic control system 1. Since this presents a potential problem for communication, the traffic control system 1 could be prepared and positioned having either several intersection control modules 10 or intersection transceivers 16 strategically positioned to minimize communication interference, while maximizing the traffic control system 1 efficiency.

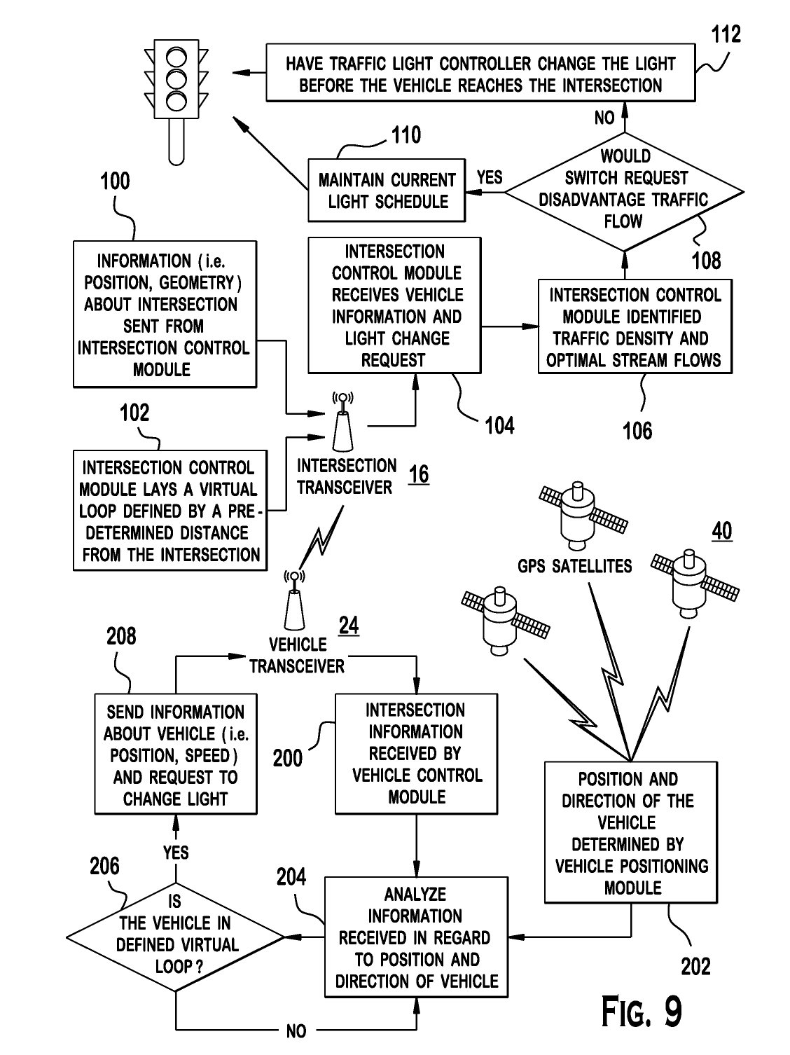

As shown in FIG. 8A, one embodiment of the traffic control system 1 is described. Several intersection control modules 10 are strategically positioned downstream, from the intersection, and toward incoming vehicles. In the embodiment shown, one intersection transceiver 16 would be positioned closer to a bend in a side roadway. This enables the intersection control module 10 to detect the incoming vehicle sooner that the obstacle (the curve) would have allowed. Furthermore, any signals 28 being broadcast from an incoming vehicle will not be hindered by the obstacle as well. Therefore, the strategic positioning of either the intersection control module 10 or intersection transceiver 16 would assist communication between the intersection control module 10 and incoming vehicles.

If the one or more intersection transceivers 16 are positioned away from the intersection control module 10, a simple connection could be provide either directly through a wire or through simple wireless communication. Additionally, if the intersection control module 10 is positioned away from the traffic light and the intersection, then the intersection control module 10 would be connected to the traffic light using the same mechanisms (wired or wireless technology). Despite the configuration, the intersection control module 10 would have the ability to switch the direction of traffic flow, by granting traffic switch requests from incoming traffic.

With reference to FIG. 8B, another embodiment of the traffic control system 1 is described, as well as the interaction of its component pieces. As shown, a single intersection control module 10 would be connected to several intersection transceivers 16. Each intersection transceivers 16 would be strategically positioned up stream from the intersection and toward the incoming traffic. Although two embodiments have been described in regard to intersection control module 10 and intersection transceivers 16 use and placement, various configurations are possible, as long as the scope and spirit of the invention are maintained.

As previously described, the intersection control module 10 acts as a hub, so called central nervous system, for the traffic control system 1, by sending and receiving signals. The intersection control module 10, also and most importantly, disseminates the dimensions that define the virtual loop detector 60. Since the virtual loop detector 60 is a theoretical loop, being dimensioned by a distance from the intersection in all directions, the loop can be adjusted. This is performed when signals are sent from the intersection control module 10, detailing the theoretical coverage of the virtual loop detector 60. The virtual loop detector 60 is not dependent on placement of the intersection control module 10 or the intersection transceivers 16. Rather, the virtual loop detector 60 need not change dimensions when conforming to various configurations of the traffic control system 1.

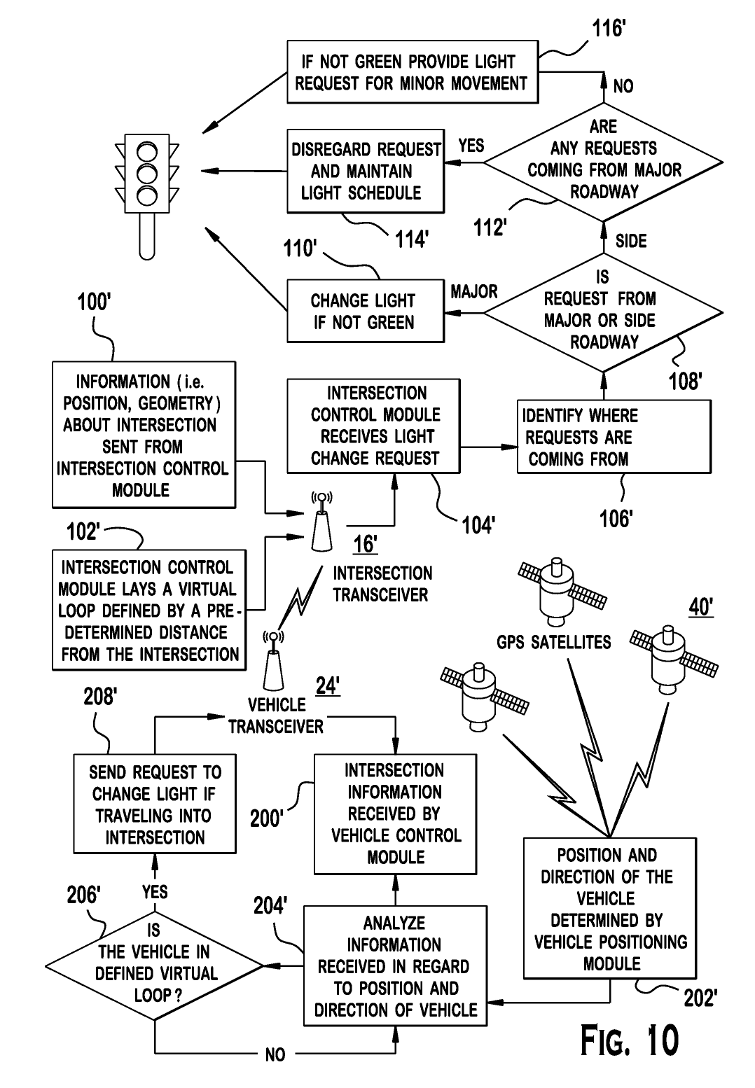

As shown in FIG. 9, the intersection control module 10 continuously sends out intersection information signals using the intersection transceiver 16 at step 100. Each signal includes, but is not limited to, the intersection geometry, location, and virtual loop detector 60 dimensions. As discussed above, the intersection control module lays a virtual loop detector 60, defined by a pre-determined distance from the intersection, at step 102. Although a constant signal 18 is being sent from the intersection control module 10, each signal 18 is merely an announcement to incoming traffic vehicles that the intersection is upcoming, providing the incoming vehicle with intersection specific information, such as location and dimensions.

At step 200, the vehicle control module 20, of an incoming vehicle, picks up this signal 18 as it moves toward the intersection. At the same time, at step 202, the vehicle's present position is determined and realized using the vehicle-positioning module 26. Since it knows its current position, the vehicle control module 20 can determine if its current position is within the virtual loop detector 60, as well as if the vehicle is traveling toward the intersection at step 206. This is realized because the vehicle control module 20 analyses the information received in regard to its known position at step 204. If it is determined that the vehicle is traveling in the virtual loop detector 60 at step 206, then the vehicle control module 20 sends a signal 28 to the intersection at step 208, which will include a green light request. Alternatively, the vehicle control module 20 may send a signal(s) 28 that include vehicle information as well as the green light request, both of which are received and processed by the intersection control module 10.

It is also possible, in another embodiment, that the vehicle control module 20 sends information concerning the vehicle and green light request before it is determined that the vehicle is in the virtual loop.

In cases where there are communication obstacles, such as a tunnel, a mountain, etc., which would affect the vehicle tracking system, the vehicle control module 20 could utilize predictive positioning. The vehicle control module 20 is capable of estimating current location using predictive positioning through previously stored and identified location coordinates, including GPS coordinates. This process, commonly known as dead reckoning, may be employed with the vehicle tracking system in order provide more efficient switch requests.

In one embodiment, vehicle control module 20 sends not just a green light request, but also current information concerning the incoming vehicle. The signal 28 sent by the vehicle control module 20 may include, but is not limited to, vehicle speed, direction, current position and a green light request. It is also possible to have the vehicle control module 20 send further information regarding vehicle activity, such as activation of a turn signal and intended direction. All signals 28 sent by the vehicle are merely requests, and the intersection control module 10 is not bound to that request.

In one embodiment, the intersection control module 10, which includes a processor 12, analyzes all incoming traffic signals 28 at step 104. The information is gathered and analyzed to determine if the flow of traffic should change according to one or more green light requests. Most importantly, at step 108, the vehicle control module 20 will determine if the vehicle, sending a green light request, is first positioned within the virtual loop detector 60 and then if the green request would promote traffic flow efficiency and not disadvantage traffic flow.

Furthermore, the intersection control module 10 will accumulate incoming signals 28 and information to help identify traffic density, including number of vehicles traveling in a particular direction, as well as identifying optimal stream flows of the intersection (step 106). Once determined, the vehicle control module 20 will determine if the green light request would disadvantage the vehicles traveling in an opposite direction of the vehicle that sent the request (step 108). The disadvantage would be determinable on opposing traffic density and number of green light requests in other directions. If it is determined that the green light request would not disadvantage adjacent traffic flow, even a pre-determined number of vehicles, then the vehicle control module 20 will have the traffic light controller module 14 change the light to green if the light is not green (step 112). However, if the vehicle control module determines that the opposing traffic would be disadvantaged, then the changing of the light will run its normal course (step 110).

In another embodiment, as shown in FIG. 10, the intersection control module 10 would still analyze incoming traffic signals 28 at step 104. However, the incoming information would not be gathered and analyzed to determine if the flow of traffic should change according to one or more green light requests. Rather, at step 108, the vehicle control module 20 will determine if the vehicle, sending a green light request, is coming from the main roadways 80 (realized as major movement) or the side roadways 70 (realized as minor movement). If the green light request is coming from the main roadway 80, then the intersection control module 10 will bias that particular green light request, and maintain green or switch traffic light. However, if the green light request is coming from the side roadways 70, which is realized as minor movement, then the traffic control module 10 will change the traffic light to green if no major movement is realized. If major movement is realized, which means that requests are being channeled in from the major roadway, then the intersection control module 10 will disregard the request and maintain a light schedule.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

What is claimed is:

1. A traffic control system for switching a traffic switch, comprising:
an intersection control module for sending information regarding an intersection, the intersection control module capable of receiving information and requests from incoming traffic and analyzing incoming traffic information in order to determine if the traffic switch changes;
a vehicle control module capable of identifying location and analyzing information received from the intersection control module, the vehicle control module capable of sending a light switch request when a vehicle is traveling toward the intersection; and
a virtual loop detector that is defined by a dimension from the intersection, wherein requests from incoming vehicles traveling within the virtual loop detector will be analyzed to determine if the traffic switch changes.

2. The traffic control system of claim 1, wherein the intersection control module is positioned near the intersection.

3. The traffic control system of claim 1, wherein the virtual loop detector is defined by a pre-determined dimension from the intersection.

4. The traffic control system of claim 1, wherein the intersection control module is positioned further downstream from the intersection.

5. The traffic control system of claim 4, wherein the intersection control module is positioned around an obstacle to receive messages from incoming traffic.

6. The traffic control system of claim 5, wherein the obstacle is a tunnel.

7. The traffic control system of claim 5, wherein the obstacle is a bridge.

8. The traffic control system of claim 1, wherein the intersection control module is capable of sending using dedicated short range communication technology.

9. The traffic control system of claim 1, wherein the intersection control module is capable of sending information through wireless Internet (WLAN) technology.

10. The traffic control system of claim 1, wherein the intersection control module is capable of sending regarding intersection position using GPS.

11. The traffic control system of claim 1, wherein the intersection control module is capable of sending regarding intersection geometry.

12. The traffic control system of claim 1, wherein the vehicle control module is an integral component of the vehicle.

13. The traffic control system of claim 1, wherein the vehicle control module is an external component of the vehicle.

14. The traffic control system of claim 1, wherein the vehicle control module is handheld device.

15. The traffic control system of claim 1, wherein the vehicle control module includes a vehicle position module, the vehicle position module capable of identifying vehicle position using GPS coordinates.

16. The traffic control system of claim 15, wherein the vehicle control module is capable of identifying location using predictive positioning through previously identified GPS coordinates.

17. The traffic control system of claim 1, wherein the vehicle control module is capable of determining if the vehicle is moving toward the identified intersection.

18. The traffic control system of claim 1, wherein the switch request includes vehicle speed, direction, and location.

19. The traffic control system of claim 18, wherein the switch request further includes activation and direction of vehicle turn signals.

20. The traffic control system of claim 1, wherein the intersection control module includes a processor in order analyze incoming traffic information and process traffic light changes.

21. A method for switching a traffic switch, comprising the steps of:
sending signals from an intersection control module, the signals including information concerning the intersection;
providing a virtual loop detector that is defined by set dimensions from the intersection;
receiving intersection signals through a vehicle control module having vehicle positioning module;
identifying a vehicle position using the vehicle positioning module;
analyzing signals received from the intersection control module in regard to vehicle position and virtual loop detector;
sending a signal including a light switch request when the vehicle is traveling toward the intersection;
receiving signals from incoming vehicles by the intersection control module;
analyzing received signals in regard to the virtual loop detector in order to determine if the traffic switch changes; and
switching or maintaining a current traffic light controller according to analysis of incoming information.

22. The method for switching a traffic switch of claim 21, wherein sending signals from an intersection control module includes information regarding intersection position and geometry.

23. The method for switching a traffic switch of claim 21, wherein sending signals is performed using dedicated short range communication (DSRC).

24. The method for switching a traffic switch of claim 21, wherein sending signals is performed using wireless Internet (WLAN).

25. The method for switching a traffic switch of claim 21, wherein identifying vehicle position using the vehicle-positioning module further comprises the step of:
calculating vehicle position through signals sent by GPS satellites.

26. The method for switching a traffic switch of claim 25, wherein identifying vehicle position using the vehicle-positioning module further comprises the step of:
predictive positioning using GPS coordinates calculated by precisely timing the signals previously sent by the GPS satellites.

27. The method for switching a traffic switch of claim 21, wherein identifying vehicle position using the vehicle-positioning module further comprises the step of:
calculating vehicle position through signals sent by a network of fixed, ground-based reference stations that broadcast a difference between the positions indicated by satellite systems and known fixed positions.

28. The method for switching a traffic switch of claim 21, wherein analyzing information received from the intersection control module in regard to the vehicle position further comprises the steps of:
determining if the vehicle position is within the virtual loop detector, which is defined by a set dimension from the intersection and moving toward the intersection.

29. The method for switching a traffic switch of claim 21, wherein sending the light switch request is performed using the same signal type as transmitted by the intersection control module.

30. The method for switching a traffic switch of claim 21, wherein analyzing incoming information and requests to determine if the traffic switch changes, further comprises the steps of:
identifying traffic density including number of vehicles traveling in a particular direction;
identifying optimal stream flows of the intersection; and
determining if the switch request would disadvantage the vehicles traveling in an opposite direction of the vehicle that sent the request.

31. A method for switching a traffic switch, comprising the steps of:
sending signals from an intersection control module, the signals including information concerning the intersection;
providing a virtual loop detector that is defined by set dimensions from the intersection;
receiving intersection signals through a vehicle control module having vehicle positioning module;
identifying vehicle position using the vehicle positioning module;
analyzing signals received from the intersection control module in regard to vehicle position and the virtual loop detector;
sending a signal including a light switch request when the vehicle is traveling toward the intersection and within the virtual loop detector;
receiving signals including the light switch request from incoming traffic by the intersection control module;
analyzing incoming information and requests from incoming vehicles in regard to position of incoming vehicles; and
switching a current traffic light controller or disregarding the request according to analysis of incoming information.

32. The method for switching a traffic switch of claim 31, wherein the step of analyzing incoming requests from incoming vehicles further comprises the step of:
determining if the light switch request is associated with minor or major movement;
disregarding a request associated with minor movement if there are co pending requests are associated with major movement; and
determining if the light switch request is appropriate by recognizing that the request is the associated with major movement or if the request is associated with minor movement and no other co pending requests are associated with major movement.
